(19) United States
(12) Patent Application Publication
(10) Pub. No.: US 2007/0078711 A1
(43) Pub. Date: Apr. 5, 2007

(54) Prioritization of advertisements for delivery over a network based on predicted inventories

(76) Inventor: Shubhasheesh Anand, Mountain View, CA (US)

Correspondence Address: BRINKS HOFER GILSON & LIONE / YAHOO! OVERTURE, P.O. BOX 10395, CHICAGO, IL, 60610, US

(21) Appl. No.: 11/243,453

(22) Filed: Oct. 3, 2005

(51) Int. Cl. G06Q 30/00

(52) U.S. Cl. 705/14

(57) ABSTRACT

A method for providing advertising content for display in a page over a network is disclosed. The method may include determining at least one advertisement line that is qualified for display at a location in the page for the given web page visitor; determining a relative inventory scarcity value for the advertisement line; and determining a priority for the advertisement line based on the determined relative inventory scarcity value.

### TECHNICAL FIELD

The present invention relates generally to providing advertising content over a network, and more particularly, but not exclusively, to selecting an advertisement based on relative scarcity of inventory for an advertisement campaign.

### BACKGROUND

Online advertising is often an important source of revenue for enterprises engaged in electronic commerce. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. The advertisement can be selected dynamically each time the page is requested for display, for example, by a browser application.

One common variety of online advertisement is the banner advertisement, which generally features an image (animated or static) and/or text displayed at a predetermined location or position in a page. A banner advertisement usually takes the form of a horizontal rectangle at the top of the page, but it can also be arranged in a variety of other shapes at another location in the page. Typically, if a user, interacting by way of a browser application, clicks on the location, image, and/or text of the banner advertisement, the user is taken to a new page that may provide detailed information regarding the products or services associated with the banner advertisement.

Banner advertisements, as well as other kinds of advertisements, are often provided to network users on a guaranteed number of impressions basis. An “impression” may be defined as a single advertisement presented to a user. Typically, an advertiser engages a provider of advertisement services to deliver a specified total number of impressions to a targeted audience, or on a particular page associated with a certain audience, over a predetermined period of time associated with an advertisement campaign. Targeting of an audience may be based on demographic criteria, inferred user interests, or other criteria. The set of advertisement impressions to be delivered in a campaign to a targeted audience profile may be referred to as an “advertisement line.”

When a provider of advertisement services receives a request for an advertisement to be included in a web page, the provider may select from among several qualifying advertisement lines to fulfill the request. Advertisement lines that compete for a location in a page may differ with respect to the scope of their associated targeted audiences are (for example, “women aged 55+ in Rhode Island who like sports cars” as opposed to “users interested in cars”). Generally, more narrowly targeted advertisement lines are associated with smaller impression inventory and higher pricing.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the principles disclosed herein, reference will be made to the following detailed description, which is to be read in association with the accompanying drawings, wherein:

FIG. 1 provides a simplified view of one embodiment of an operating environment;

FIG. 2 illustrates one possible arrangement of components of an optimizer/arbitrator for advertisement services;

FIG. 3 illustrates components of a system for providing prioritizations for advertisement lines that qualify for inclusion in a location in a requested page;

FIG. 4 is a logical flow diagram generally showing one embodiment of a process for enabling the display of a page that includes an advertisement selected based on priority values and other criteria;

FIG. 5 is a logical flow diagram generally showing one embodiment of a process for selecting an advertisement for inclusion in a page location based on prioritization of qualifying advertisement lines;

FIG. 6 is a logical flow diagram generally showing one embodiment of a process for determining prioritization of advertisement lines based on incidence calculations;

FIG. 7 is a logical flow diagram generally showing one embodiment of a process for determining incidence for advertisement lines; and

FIG. 8 is a logical flow diagram generally showing one embodiment of a process for determining an incidence value for an advertisement line that qualifies for inclusion in a page location.

### DETAILED DESCRIPTION

Reference will now be made to the accompanying drawings, which form a part hereof, and which show, by way of illustration, specific exemplary embodiments. The principles described herein may, however, be embodied in many different forms, and this specification should not be construed to limit the claims. Rather, these embodiments are provided so that this disclosure will be thorough and complete to those skilled in the art.

A technique for establishing a priority for an advertisement line based on a determination of the relative scarcity of inventory for the advertisement line is disclosed. In one example, depending on the nature of the advertisement line or advertisement campaign, “inventory” for a given advertisement line may include a predicted number of impressions available for display to users at a specific location in a specific page, and for a specified period of time. Inventory may be determined based on historical advertisement delivery information. The relative scarcity determination may be referred to as the “incidence level” of the advertisement line. A lower incidence level (i.e., greater relative scarcity of available inventory) may be associated with a more narrowly or specifically targeted advertisement line. For example, an advertisement campaign targeting “men 25-34 in San Diego interested in computers” would generally have a lower incidence level than a campaign targeting “men 25-34 in California,” which in turn would generally have a lower incidence level than a campaign that broadly targeted “men 25-34.”

In one embodiment, incidence is determined based on the predicted available inventory for an advertisement line in relation to total available inventory for a plurality of advertisement lines, such as all active advertisement lines that qualify for inclusion in locations in a set of pages for which advertisement services are provided, such as a portal site or a set of related sites. Additionally, or alternatively, incidence may be determined by dividing the predicted inventory for the advertisement line by a constant number. The number could represent the total ad inventory on the portal, the total ad inventory on the web network, or other values. For an advertisement line that qualifies for a given location in a page but has no associated inventory information, an average of the incidence levels of other advertisement lines qualifying for the page location may be employed as its incidence value. A default incidence value, such as a lowest incidence value, may be used, for example, with a page location that is newly-configured for placement of advertisements. Other values and method may also be used.

The assigned priority may be employed in selecting from among competing advertisement lines for a given location in a page (such as a web page) that is requested over a network. A priority determined in such a manner may be used along with other forms of advertisement line prioritization and other kinds of advertisement selection criteria, such as inferred user profile information, in providing an advertisement for display over the network. Priorities may be assigned to guaranteed impression-based advertisement lines, including banner advertisement lines enabling more narrowly targeted advertisement lines to be given relatively higher priority in selection, which can improve the delivery performance for the advertisement campaigns associated with those lines. Because a lower incidence is generally associated with more narrowly targeted advertisement lines, incidence-based prioritization may enable such advertisement lines to be given higher priority in selection and delivery, thereby enabling more advertisement lines to more consistently meet contractual impression goals, and also deliver higher priced advertisements to scarce user bases

Illustrative Operating Environment

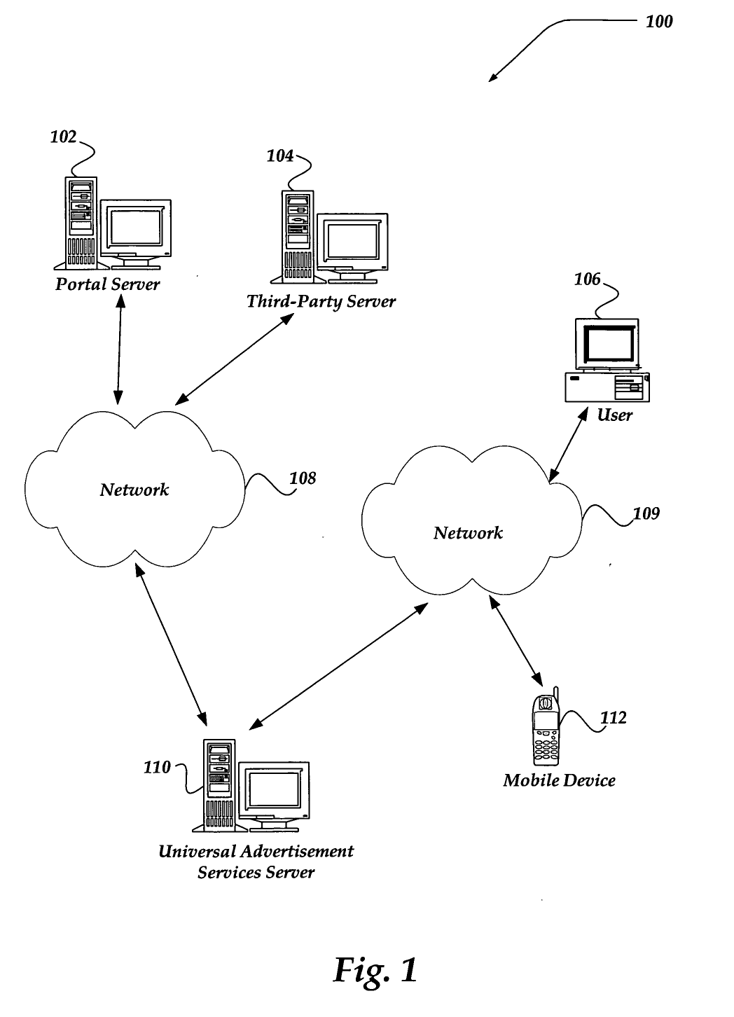

FIG. 1 provides a simplified view of one embodiment of an environment. Not all of the depicted components may be required, however, and some embodiments of the invention may include additional components not shown in the figure. Variations in the arrangement and type of the components may be made without departing from the spirit or scope of the claims as set forth herein.

As illustrated in FIG. 1, environment 100 includes universal advertisement services server 110, which provides a unified platform for selection, optimization, and distribution of advertisements for inclusion in pages, such as web pages. Pages are provided to users by portal server 104 and/or third-party server 102. In FIG. 1 users are represented by user 106 (depicted as a conventional personal computer) and web-enabled mobile device 112.

Some or all of universal advertisement services server 110, portal server 104, and third-party server 102 are in communication by way of network 108. It will be understood that universal advertisement services server 110 and portal server 104 may each represent multiple linked computing devices, and that multiple third-party servers, such as third-party server 102, may be included in environment 100. Network 108 may be regarded as a private network connection and may include, for example, a virtual private network or an encryption or other security mechanism employed over the public Internet, or the like.

User 106 and mobile device 112 represent user-interactive devices that typically run browser applications, and the like, to display requested pages received over a network. Such devices are in communication with portal server 104 and/or third-party server 102 by way of network 109. Network 109 may be the public Internet and may include all or part of network 108; network 108 may include all or part of network 109.

Portal server 104, third-party server 102, universal advertisement services server 110, user device 106, and mobile device 112 each represent computing devices of various kinds. Such computing devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, user device 106 may be configured to execute a browser application that employs HTTP to request information, such as a web page, from a web server, which may be a process executing on portal server 104 or third-party server 102.

Networks 108-109 are configured to couple one computing device to another computing device to enable communication of data between the devices. Networks 108-109 may generally be enabled to employ any form of machine-readable media for communicating information from one device to another. Each of networks 108-109 may include one or more of a wireless network, a wired network, a local area network (LAN), a wide area network (WAN), a direct connection such as through a Universal Serial Bus (USB) port, and the like, and may include the set of interconnected networks that make up the Internet. On an interconnected set of LANs, including networks employing differing protocols, a router acts as a link between LANs, enabling messages to be sent from one to another. Communication links within LANs typically include twisted wire pair or coaxial cable. Communication links between networks may generally use analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Remote computers and other network-enabled electronic devices may be remotely connected to LANs or WANs by way of a modem and temporary telephone link. In essence, networks 108-109 may include any communication method by means of which information may travel between computing devices.

The media used to transmit information across communication links as described above illustrate one type of machine-readable media, namely communication media. Generally, machine-readable media include any media that can be accessed by a computing device or other electronic device. Machine-readable media may include processor-readable media, data storage media, network communication media, and the like. Communication media typically embody information that includes processor-readable instructions, data structures, program components, or other data in a modulated data signal such as a carrier wave or other transport mechanism. Such media may include any information delivery media. The terms “modulated data signal” and “carrier wave signal” include a signal that has one or more of its characteristics set or changed in such a manner as to encode information, instructions, data, and the like in the signal. By way of example, communication media include wired media such as twisted pair, coaxial cable, fiber optic cable, and other wired media, and wireless media such as acoustic, RF, infrared, and other wireless media.

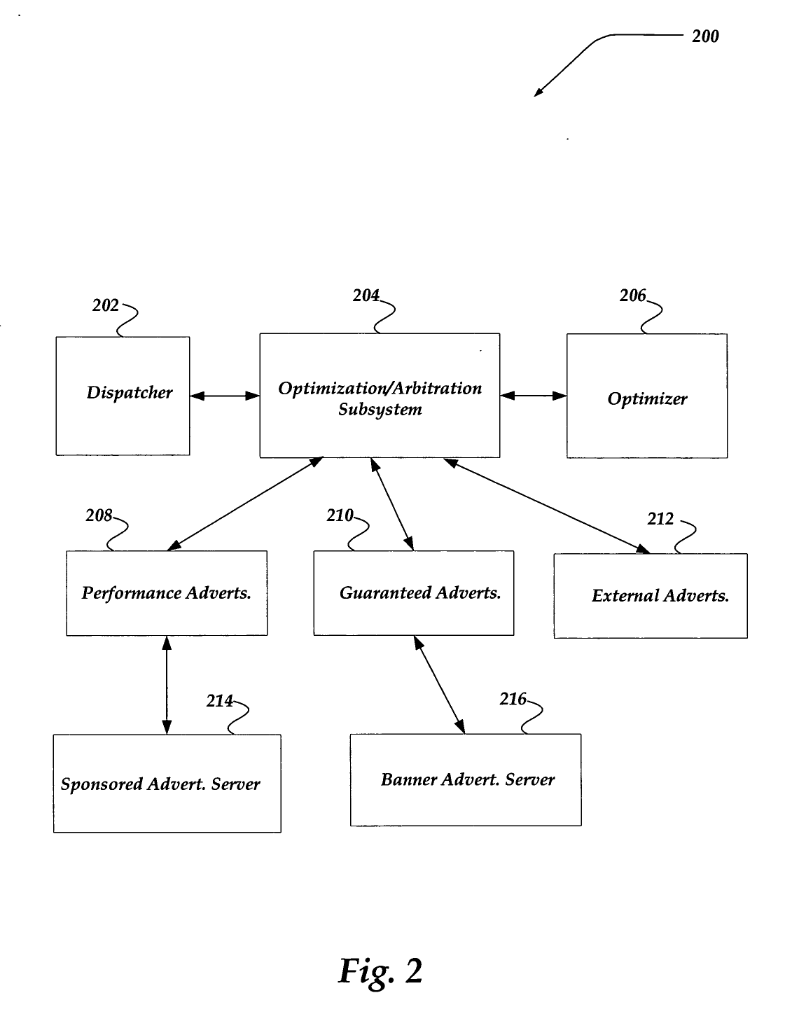

FIG. 2 illustrates one possible arrangement of components of an optimizer/arbitrator for advertisement services. Optimizer/arbitrator 200 may be part of a universal advertisement services architecture, which may correspond to universal advertisement services server 110. Optimizer/arbitrator 200 enables retrieval of qualifying advertisements for a given location in a page and selection of an optimal advertisement. As shown in FIG. 2, optimizer/arbitrator 200 includes an optimization/arbitration subsystem 204, which includes or may be regarded as the arbitrator proper. Optimization/arbitration subsystem 204 interacts with or includes dispatcher 202, which communicates requests for advertisements, and optimizer 206, which enables selection of a best available advertisement based on predetermined rules or policies. Though not specifically shown in FIG. 2, optimization/arbitration subsystem 204 may include or be coupled to other components, including a configuration manager for enabling configuration requirements to be specified for advertisement locations in a page, and including an advertisement client server for communication between a requesting web server and dispatcher 202.

Optimization/arbitration subsystem 204 communicates with performance advertisements component 208, guaranteed impression advertisements component 210, and external advertisements component 212. Performance advertisements component 208 interacts with sponsored advertisement server 214. Similarly, guaranteed impression advertisements component 210 interacts with banner advertisement server 216.

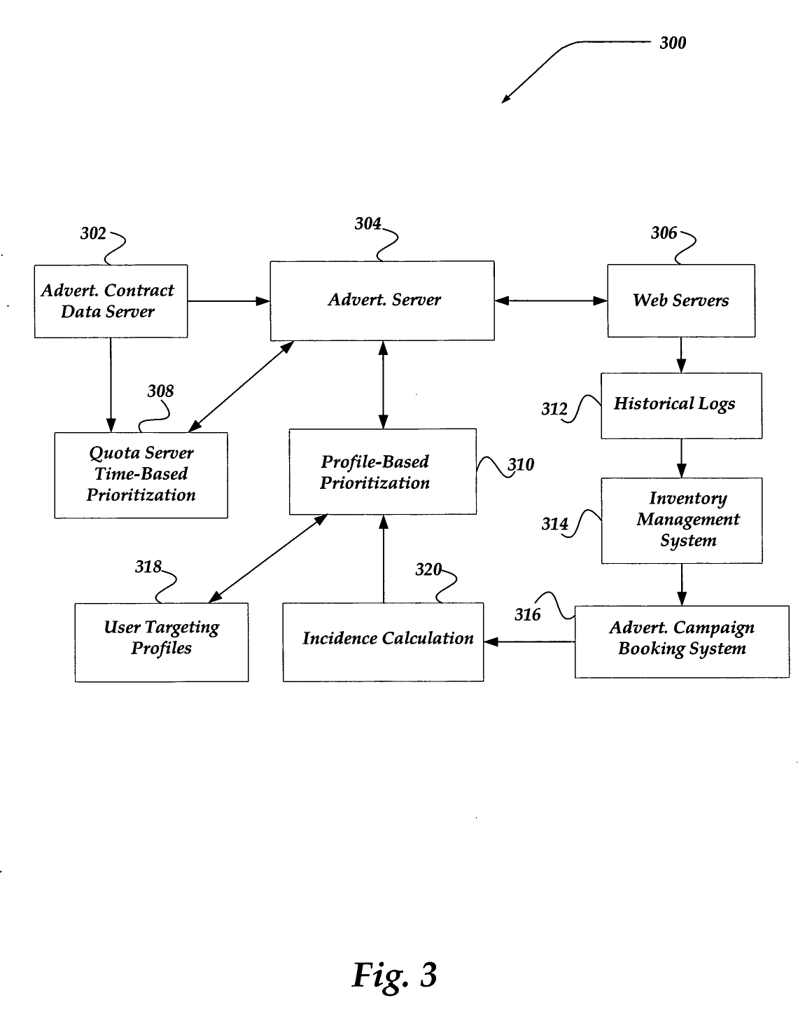

FIG. 3 illustrates components of a system for providing prioritizations for advertisement lines that qualify for a location in a requested page. Components in system 300 may be a part of one or more of the components illustrated in FIG. 2 and may also be part of, or coupled to, a universal advertisement services architecture. System 300 includes advertisement server 304, which may be, for example, banner advertisement server 216. Advertisement server 304 communicates with web servers 306. This communication may be mediated by one or more of the components illustrated in FIG. 2, such as optimization/arbitration subsystem 204. Web servers 306 request and are provided advertisements (which may be, for example, advertisement impressions) by advertisement server 304. Advertisement contract data server 302 provides data relating to delivery goals for advertisement lines to advertisement server 304.

Selection of an advertisement from among competing advertisement lines that qualify for a location in a requested page may be based in part on priority values assigned to particular advertisement lines. Priority values may be determined by, among other components, quota server 308, which enables time-based prioritizations, and profile-based prioritization component 310. Information regarding determined prioritization of advertisement lines may be provided to advertisement server 304. For example, profile-based prioritization component 310 may be employed to determine an advertisement line from among qualifying advertisement lines that has the lowest incidence value. Advertisement server 304 uses priorities determined by quota server 308, profile-based prioritization component 310, and other components not necessarily shown in FIG. 3, to select an advertisement line for delivery to a requesting web server.

Quota server 308 manages workload for advertisement server 304 by periodically calculating and allocating delivery quotas for particular advertisement lines to advertisement server 204. A quota may be based on a rate calculation algorithm, which may be applied to traffic projections provided by advertising contract data server 302.

Profile-based prioritization component 310 may provide priority values that are based on incidence calculation 320 for advertisement lines as well as on user targeting profiles 318. Incidence, which may be a relative value that measures the scarcity of available inventory for an advertisement line, may be calculated by advertisement campaign booking system 316 based on data provided by inventory management system 314. Advertisement campaign booking system 316 also determines average incidence values for particular page locations based on the incidences of all active advertisement lines qualifying for that location. Incidence calculation 320 for advertisement lines, and calculation of average incidence values, may be performed periodically, such as daily or weekly. The period may depend on how frequently data changes in inventory management system 314.

Inventory management system 314 is employed for predictions of network traffic, including page views, and inventory management system 314 determines advertisement inventories based on such predictions. The predictions of network traffic may be based on information derived from historical logs component 312, which receives data regarding historical traffic from web servers 306.

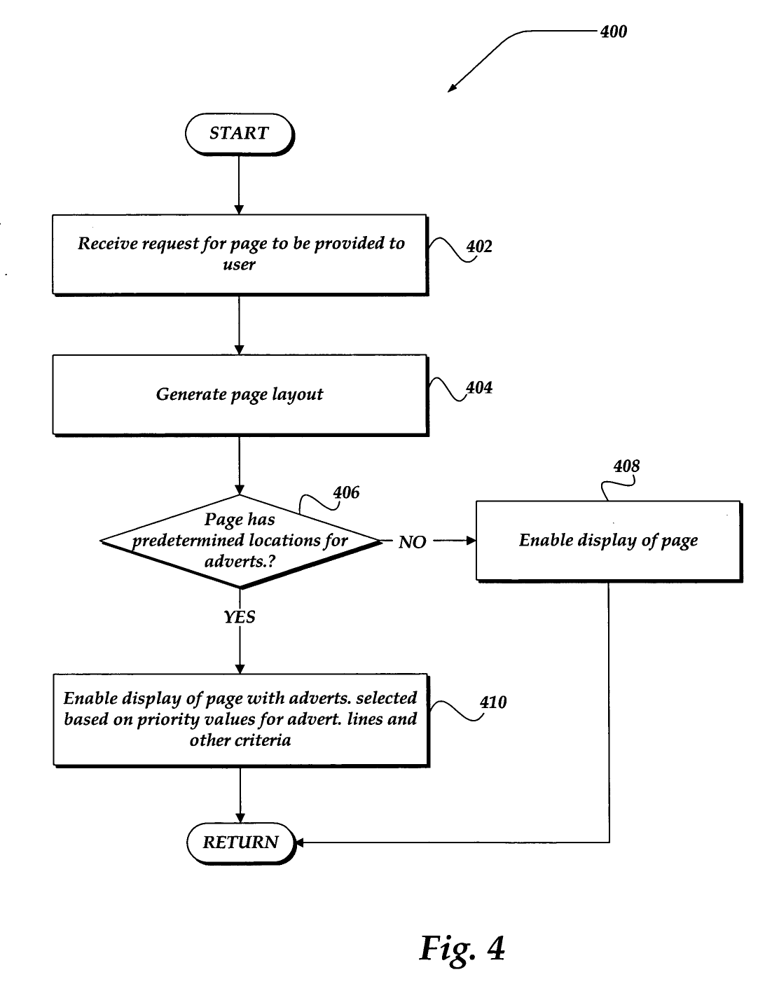

FIG. 4 is a logical flow diagram generally showing one embodiment of a process for enabling the display of a page that includes an advertisement selected based on priority values and other criteria. Following a start block, process 400 flows to block 402, where a request is received (for example, by a web server) for a page to be provided over a network to a user. Typically, the request may be sent by a browser application; the provided page is displayed to the user, who interacts with the browser application. Processing flows next to block 404, where page layout and content for the requested page is generated. Process 400 then flows to decision block 406, at which it is determined whether there are advertisements to be included in locations in the requested page. If there is no advertisement location in the requested page, process 400 branches to block 608, where the display of the page may be enabled without requiring additional advertisement services, and processing then returns to a calling process to perform other actions. If, however, there is at least one advertisement location in the requested page, process 400 flows to block 410, where the display of the page, with one or more advertisements included at specified locations, may be enabled. The advertisements are selected based on priority values for advertisement lines that qualify for inclusion in the page locations, as well as other criteria, such as user profile data. Process 400 then returns to a calling process to perform other actions.

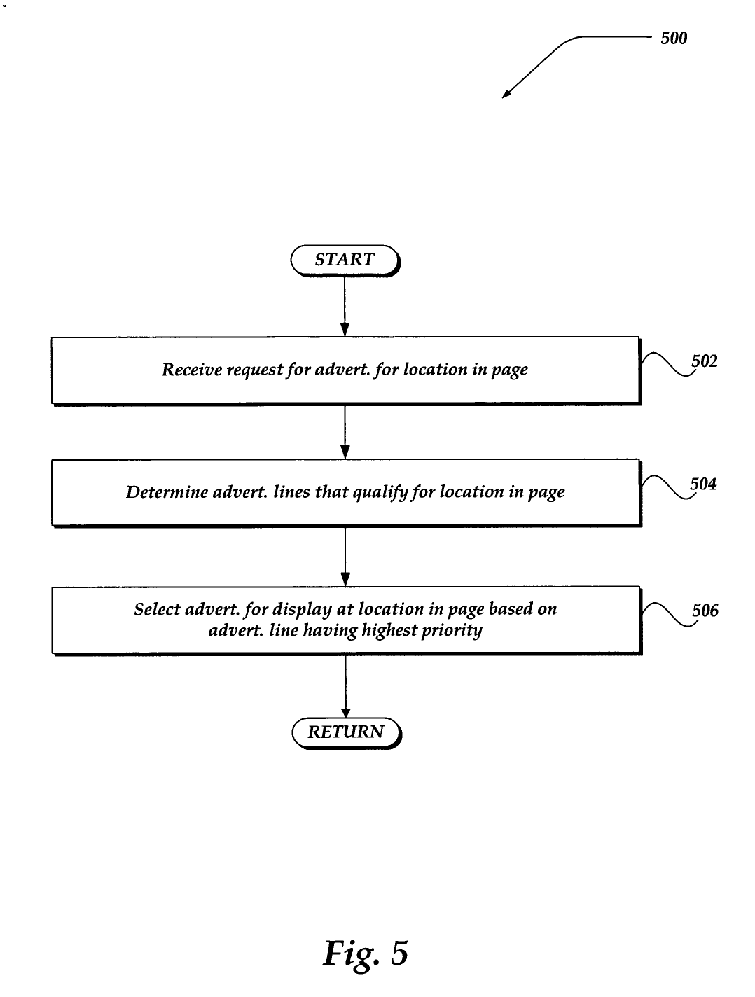

FIG. 5 is a logical flow diagram generally showing one embodiment of a process for selecting an advertisement for inclusion in a page location based on prioritization of qualifying advertisement lines. Following a start block, process 500 flows to block 502, where a request for an advertisement to be included in a location in a page may be received. Process 500 flows next to block 504, at which advertisement lines that qualify for the page location may be determined. The determination of qualifying advertisement lines may be based on a configuration associated with the page location, which may specify particular categories of advertisements. The determination of qualifying advertisement lines may also be based on characteristics of the targeted audiences of the advertisement lines. Other factors may also be considered. Processing advances to block 506, where an advertisement is selected for display at the page location based on an advertisement line that is determined to have a highest priority. The priority may be based on incidence as well as on other criteria, and on a combination of various prioritization criteria. Process 500 then returns to a calling process to perform other actions.

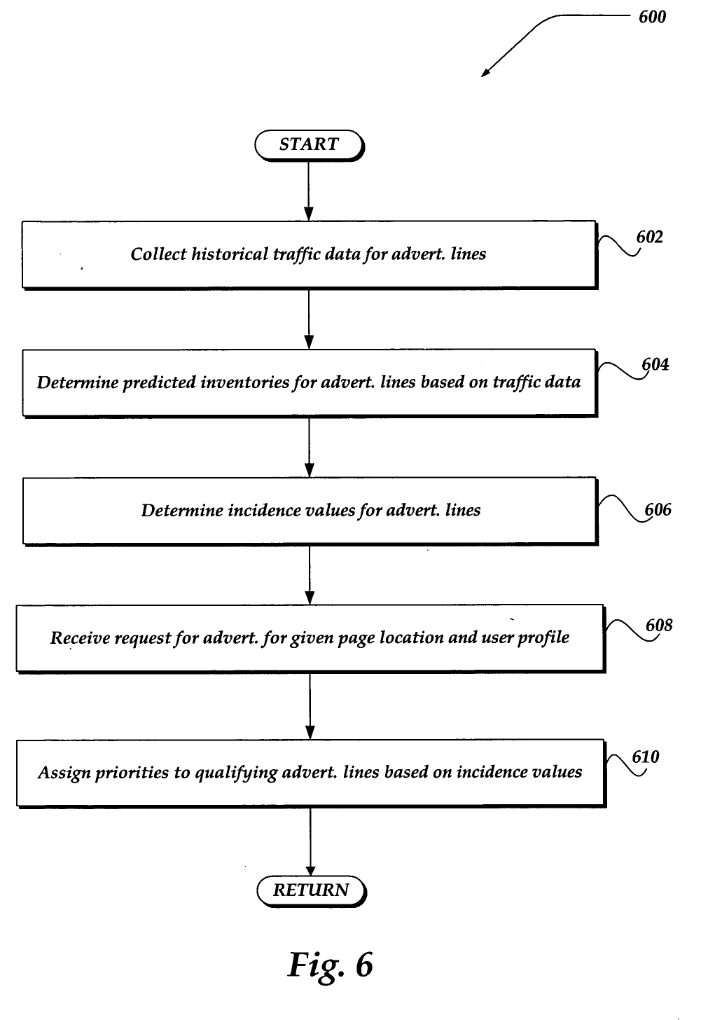

FIG. 6 is a logical flow diagram generally showing one embodiment of a process for determining prioritization of advertisement lines based on incidence calculations. Following a start block, process 600 flows to block 602, where historical traffic data relating to advertisement lines may be collected. Processing then steps to block 604, where predicted inventories are determined for advertisement lines based on the collected historical traffic data. Process 600 next flows to block 606, at which incidence values, associated with relative scarcity of inventory, may be determined for advertisement lines. As noted above, such a step may be performed periodically. Process 600 then proceeds to block 608, at which a request is received for an advertisement to be included in a specific location in a page having particular content. The request may also include other information, such as user profile information for the end user requesting the page over the network, and the like. Processing then steps to block 610, where priorities may be assigned to advertisement lines that qualify for inclusion in the page location based on determined incidence values. For example, a highest priority may be assigned to a qualifying advertisement line associated with a lowest incidence value. Process 600 then may return to a calling process to perform other actions.

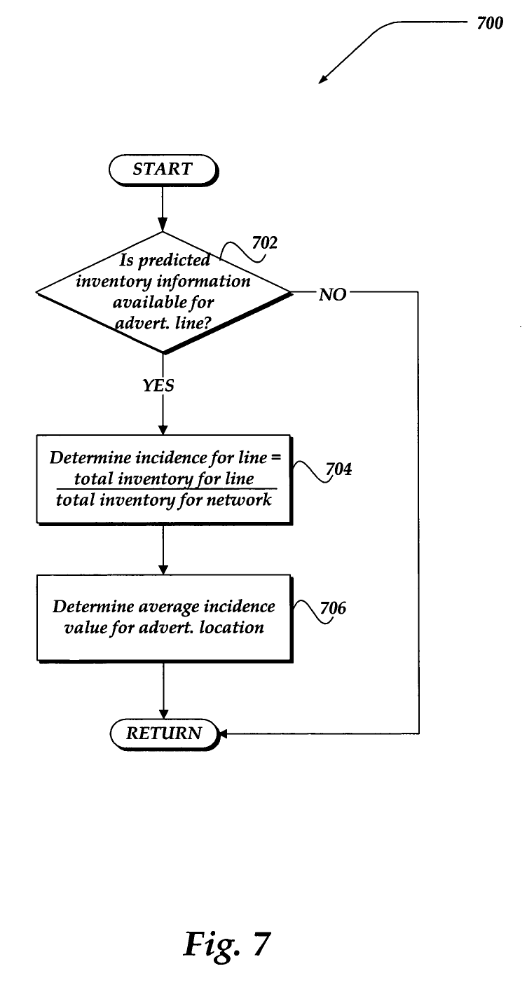

FIG. 7 is a logical flow diagram generally showing one embodiment of a process for determining incidence for advertisement lines. Process 700 may be performed periodically, for example as a periodic batch process, to predetermine incidence levels for advertisement lines. Process 700 begins, after a start block, at decision block 702, where it is determined whether predicted inventory information is available for an advertisement line. If not, processing returns to a calling process to perform other actions. If, however, predicted inventory information is available for the advertisement line, process 700 branches to block 704, at which an incidence level is determined. In one embodiment, incidence for the advertisement line may be based on the following formula:

$$incidence = \frac{total inventory for the target of an advertisement line}{\begin{matrix}total inventory on the portal carrying advertisements \\ ( active advertisements )\end{matrix}}$$

Other formulas may also be used to determine incidence. Actions associated with decision block 702 and block 704 may be performed for each active advertisement line managed by an advertisement services provider. In another embodiment, a constant number may be employed for the denominator in the formula.

Process 700 then flows to block 706 where, for one or more advertisement locations, such as all appropriate advertisement locations for the set of all pages in the network of pages or sites managed by the advertisement services provider, an average of incidence levels is determined for advertisement lines that potentially qualify for the location. This average incidence value may be used for advertisement lines having no inventory information for calculation of an incidence level according to the formula given above. Process 700 then may return to a calling process to perform other actions.

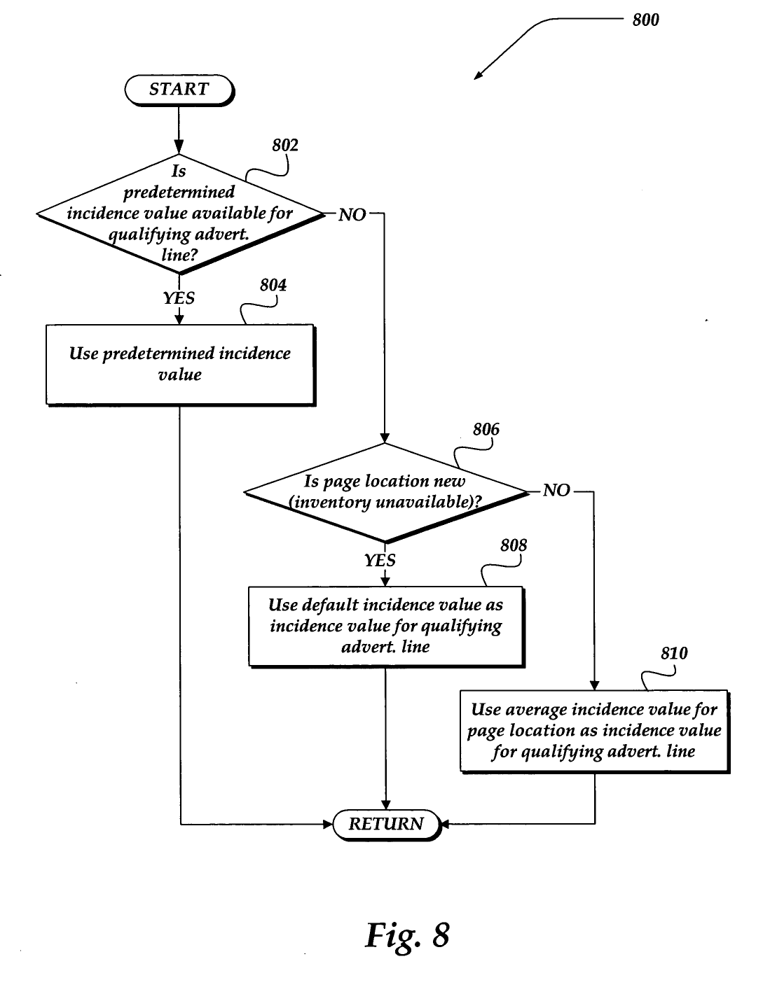

FIG. 8 is a logical flow diagram generally showing one embodiment of a process for determining an incidence value for an advertisement line that has been determined to qualify for inclusion in a page location. Process 800 begins, after a start block, at decision block 802, at which it is determined whether a predetermined incidence value is already available for the qualifying advertisement line, such as an incidence level determined in accordance with block 704 of process 700. If so, processing flows to block 804, where the predetermined incidence value is employed for the advertisement line. Processing then returns to a calling process to perform other actions.

If, however, the determination at decision block 802 is negative, because, for example, predicted inventory information is not available for the advertisement line, process 800 flows to decision block 806, at which it is determined whether the given page location is a “new” location, in the sense that inventory information is not yet available for advertisement lines scheduled or booked for that page location. If the page location is new, processing flows to block 808, where a default incidence value is used for the advertisement line. For example, a lowest incidence value may be employed to assign high priority to advertisement lines associated with the new page location. Process 800 then returns to a calling process to perform other actions. If, however, the determination at decision block 806 is negative, the page location is not new. In this case, process 800 flows to block 810, where the predetermined average incidence value for the page location, which may be determined in accordance with block 706 of FIG. 7, is used as the incidence value for the advertisement line. Process 800 then returns to a calling process to perform other actions.

It is therefore intended that the foregoing detailed description be regarded as illustrative rather than limiting, and that it be understood that it is the following claims, including all equivalents, that are intended to define the spirit and scope of this invention.

We claims:

1. A method for providing advertising content for display in a page over a network, comprising:
determining at least one advertisement line that is qualified for display at a location in the page;
determining a relative inventory scarcity value for the advertisement line; and
determining a priority for the advertisement line based on the determined relative inventory scarcity value.

2. The method of claim 1, further comprising:
employing the determined priority to select an advertisement for display in the page.

3. The method of claim 1, wherein the advertisement is at least one of a banner advertisement, a guaranteed advertisement, or an impression-based advertisement.

4. The method of claim 1, wherein determining the relative inventory scarcity value for the advertisement line further comprises:
determining a predicted inventory value for the advertisement line; and
dividing the predicted inventory value for the advertisement line by one of (1) a sum of inventory values for one or more advertisement lines, or (2) a constant.

5. The method of claim 1, wherein determining the relative inventory scarcity value for the advertisement line further comprises determining an average value for one or more advertisement lines associated with the location in the page.

6. The method of claim 1, wherein determining the relative inventory scarcity value for the advertisement line further comprises employing a default value.

7. A server for providing advertising content for display in a page over a network, comprising:
a memory for use in storing data and instructions; and
a processor in communication with the memory and for enabling actions based on the stored instructions, including:
determining at least one advertisement line that is qualified for display at a location in the page;
determining a relative inventory scarcity value for the advertisement line; and
determining a priority for the advertisement line based on the determined relative inventory scarcity value.

8. The server of claim 7, further comprising:
employing the determined priority to select an advertisement for display in the page.

9. The server of claim 7, wherein the advertisement is at least one of a banner advertisement, a guaranteed advertisement, or an impression-based advertisement.

10. The server of claim 7, wherein determining the relative inventory scarcity value for the advertisement line further comprises:
determining a predicted inventory value for the advertisement line; and
dividing the predicted inventory value for the advertisement line by one of (1) a sum of inventory values for one or more advertisement lines, or (2) a constant.

11. The server of claim 7, wherein determining the relative inventory scarcity value for the advertisement line further comprises determining an average value for one or more advertisement lines associated with the location in the page.

12. The server of claim 7, The method of claim 1, wherein determining the relative inventory scarcity value for the advertisement line further comprises employing a default value.

13. A client for displaying advertising content in a page over a network, comprising:
a memory for use in storing data and instructions; and
a processor in communication with the memory and for enabling actions based on the stored instructions, including:
enabling a determination of at least one advertisement line that is qualified for display at a location in the page;
enabling a determination of a relative inventory scarcity value for the advertisement line; and
enabling a determination of a priority for the advertisement line based on the determined relative inventory scarcity value.

14. The client of claim 13, further comprising:
displaying an advertisement in the page, wherein the advertisement is selected based on the determined priority.

15. The client of claim 13, wherein the advertisement is at least one of a banner advertisement, a guaranteed advertisement, or an impression-based advertisement.

16. The client of claim 13, wherein enabling the determination of the incidence level for the advertisement line further comprises:
enabling a determination of a predicted inventory value for the advertisement line; and
enabling a division of the predicted inventory value for the advertisement line by one of (1) a sum of inventory values for one or more advertisement lines, or (2) a constant.

17. The client of claim 13, wherein enabling the determination of the relative inventory scarcity value for the advertisement line further comprises determining an average value for one or more advertisement lines associated with the location in the page.

18. The client of claim 13, wherein enabling the determination of the relative inventory scarcity value for the advertisement line further comprises employing a default value.

19. A mobile device for displaying advertising content in a page over a network, comprising:
a memory for use in storing data and instructions; and
a processor in communication with the memory and for enabling actions based on the stored instructions, including:
enabling a determination of at least one advertisement line that is qualified for display at a location in the page;
enabling a determination of a relative inventory scarcity value for the advertisement line; and
enabling a determination of a priority for the advertisement line based on the determined relative inventory scarcity value.

20. A processor-readable medium having processor-executable code thereon for enabling actions for performing actions to provide advertising content for display in a page over a network, comprising:
determining at least one advertisement line that is qualified for display at a location in the page;
determining a relative inventory scarcity value for the advertisement line; and
determining a priority for the advertisement line based on the determined relative inventory scarcity value.
